(19) United States
(12) Patent Application Publication
(10) Pub. No.: US 2026/0187710 A1
(43) Pub. Date: Jul. 2, 2026

(54) Immersive Item Cards

(71) Applicant: eBay Inc., San Jose, CA (US)

(72) Inventors: Prerna Dubey, San Jose, CA (US); Timothy Jennings Sears, Portland, OR (US); Sujan Kanna, Naperville, IL (US); Clydies Freeman, Dallas, TX (US); Lia DiValentin, Brooklyn, NY (US); Julian Ivory Body, San Francisco, CA (US); Harshal Parikh, White Plains, NY (US); Phil James Olson, Minneapolis, MN (US); Rajalakshmi Ramachandran Pillay, Los Gatos, CA (US)

(73) Assignee: eBay Inc., San Jose, CA (US)

(21) Appl. No.: 19/002,651

(22) Filed: Dec. 26, 2024

(51) Int. Cl. G06Q 30/0601; G06F 3/04845; G06T 7/194; G06T 15/20

(52) U.S. Cl. CPC G06Q 30/0643; G06F 3/04845; G06Q 30/0625; G06T 7/194; G06T 15/205

(57) ABSTRACT

An immersive trading card experience is described. In one or more implementations, an image of a front of a trading card is obtained and segmented into two or more layers displayable at different depths. Listing information corresponding to the trading card is retrieved for use as the trading card rear and is adapted to include real-time trending information for additional listings of the trading card. In response to the trading card being returned in a search result, an enhanced item card is communicated to a computing device. The enhanced item card includes the trading card front with the layers displayable at different depths. A rotatable display of the enhanced item card includes the layers displayable at different depths as an enhanced image of the trading card front and includes the listing information as the trading card rear.

### BACKGROUND

When buying trading cards through online marketplaces, one of the biggest challenges is the inability to physically inspect the cards before purchasing. Buyers must rely solely on flat, two-dimensional photos of the trading cards and descriptions provided by the seller, which can sometimes be misleading or incomplete. Small details like surface scratches, centering issues, or wear on the edges might not be visible in the images or disclosed in the description, leading to potential disappointment when the card arrives. With conventional approaches it can also be difficult to analyze aspects of a particular trading card in relation to other similar trading cards.

### SUMMARY

In accordance with the described techniques, a search query is submitted from a client device to a server device for an item such as a trading card, the search results returned from the server include the item, and the item has a three-dimensional (3D) immersive experience associated with it. In the scenario where the item returned is a trading card, for instance, the trading card has a 3D, immersive trading card that can be presented in various contexts. To provide the 3D immersive experience, in at least one example, an image of the front of the card is segmented into different layers (e.g., a character itself, a “photo” of the character, a card background, a frame, icons, etc.). The image segments are arranged and presented via a user interface so that they float in a movable 3D perspective view of the front of the card and move as the card is manipulated via user input. In the immersive experience, the item card can be flipped (e.g., with a flip gesture) to show listing information regarding the item card, including trending information for other listings of the item.

At a client device, gestures provide a tactile experience with the item card. A listing-scroll-gesture can scroll through multiple item cards included in the search results, such as in a “carousel” of the cards; a flip-gesture can rotate an individual item card between the item card front (which comprises the movable 3D perspective view or parallax) and the item card rear (which may comprise listing information, e.g., that replaces a rear image of a trading card); a 3D-rotation-gesture can move the 3D perspective view of the image of the item card front so that the different layers can be examined. In at least one implementation, the listing-scroll-gesture can be in a direction perpendicular to a direction of the flip-gesture (e.g., up-down vs. left-right), although in other implementations it may be a same direction. Physical defects of the item can be highlighted in the 3D image of the item card front as well. Within the listing information displayed as the item card rear, an interactive user interface element can display real time trending information, such as information specific to a particular trading card or item.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a user interface for an immersive item card experience.

FIG. 3 depicts another example of a user interface for an immersive item card experience.

FIG. 4 depicts another example of a user interface for an immersive item card experience.

FIG. 5 depicts another example of a user interface for an immersive item card experience.

FIG. 6 depicts another example of a user interface for an immersive item card experience.

FIG. 7 depicts another example of a user interface for an immersive item card experience.

FIG. 8 depicts another example of a user interface for an immersive item card experience.

FIG. 9 depicts an exploded view of another example of the user interface for an immersive item card experience.

FIG. 10A, FIG. 10B, and FIG. 10C depict another example of a user interface for an immersive item card experience.

FIG. 11A, FIG. 11B, FIG. 11C, and FIG. 11D depict another example of a user interface for an immersive item card experience.

FIG. 12 depicts another example of a user interface for an immersive item card experience.

FIG. 13 depicts another example of a user interface for an immersive item card experience.

FIG. 14A, FIG. 14B, and FIG. 14C depict another example of a user interface for an immersive item card experience.

FIG. 15 depicts a procedure in an example implementation of immersive item cards.

FIG. 16 illustrates an example of a system that may implement various techniques described herein.

### DETAILED DESCRIPTION

### Overview

When buying trading cards through online marketplaces, one of the biggest challenges is the inability to physically inspect the cards before purchasing. Buyers must rely solely on flat, two-dimensional (2D) photos of the trading cards and descriptions provided by the seller, which can sometimes be misleading or incomplete. Small details like surface scratches, centering issues, or wear on the edges might not be visible in the images or disclosed in the description, leading to potential disappointment when the card arrives. With conventional approaches it can also be difficult to analyze aspects of a particular trading card in relation to other similar trading cards.

In the swiftly evolving technical landscape, recent innovations such as augmented reality (AR) and virtual reality (VR), three-dimensional (3D) experiences, and Generative Artificial Intelligence (AI) have set new benchmarks. With these dynamics, buyers can be highly receptive to innovative item card experiences that redefine online shopping. Immersive experiences can captivate enthusiast buyers by delivering crucial information intuitively, enhancing their decision-making process.

Buyers and potential purchasers searching online for collectible cards may desire to see the most minute details about the item under consideration before making a purchase decision. They may also desire to obtain the most relevant information for those trading cards such as market pricing trends, grading and release information, and the like, in a convenient and easily accessible manner while searching for their item of interest.

To address these and other issues, an immersive item card experience provides interaction with cards generated and presented for items that offer a more engaging and visually stimulating experience in a three-dimensional, tactile format allowing for in-depth inspection. As further described herein, the immersive item cards allow users to delve into a deeper exploration of item details through playful interaction with the immersive cards.

Using the described techniques, for instance, users are able to inspect three-dimensional presentations of trading cards in depth and observe any tears, scratches, or blunted corners for their cards of interest. The described techniques also enable users to flip a presented immersive card as if holding a physical card in the palm of their hand and obtain additional relevant information about the item for which the card is generated on a new rear of the card.

In one or more implementations, a rear of an immersive item card is configured to include a presentation of curated information about the item being listed. In the scenario where the item card is generated and presented for a physical trading card, for instance, the presentation of curated information may, in the immersive 3D item card experience, replace an image of a rear of the trading card, such that when the immersive item card is flipped in the user interface from an enhanced front of the card to a rear of the card, the curated information is presented in place of an image of an actual rear of the trading card. When the item is for a different type of physical item (not a trading card), in the immersive 3D item card experience, the presentation of curated information may provide additional context for a listing of the item, additional images of the item, and so forth.

Examples of the curated information include but are not limited to real-time trending information related to the item listed (e.g., historical pricing of the particular listing, trends in pricing of the item or similar items, numbers of sales of the item or similar items, numbers of new listings of the item or similar items, number of days listed, price ranges, and so on). In addition, or alternatively, at least a portion of the rear of the immersive item card may be configured to present an artificial intelligence generated synopsis associated with the item being listed. For example, generative artificial intelligence (AI) may be prompted, in real time, when a gesture to flip the item card is received, to generate a synopsis of the item listing, such as describing the item and/or describing trends observed with the same or similar items. In other words, the generative AI may be prompted to provide a summarized description of the item listing's details and/or trends relevant to the listing. This synopsis or “summary” may then be incorporated into and presented as part of the rear of the immersive item card. Alternatively or additionally, the item card rear may include a variety of other information, such as any of one or more attributes of the listing, e.g., any images not displayed on the item card front, condition grading information, special designations of the item (e.g., limited release, authentic, and so on), and so forth.

The immersive item card experience provided by the immersive item cards not only provides an improved user interface for inspecting details about items such as trading cards, but also the experience may boost buyer engagement and encourage repeat visits, making a search results page (SRP) a go-to destination for future purchases.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

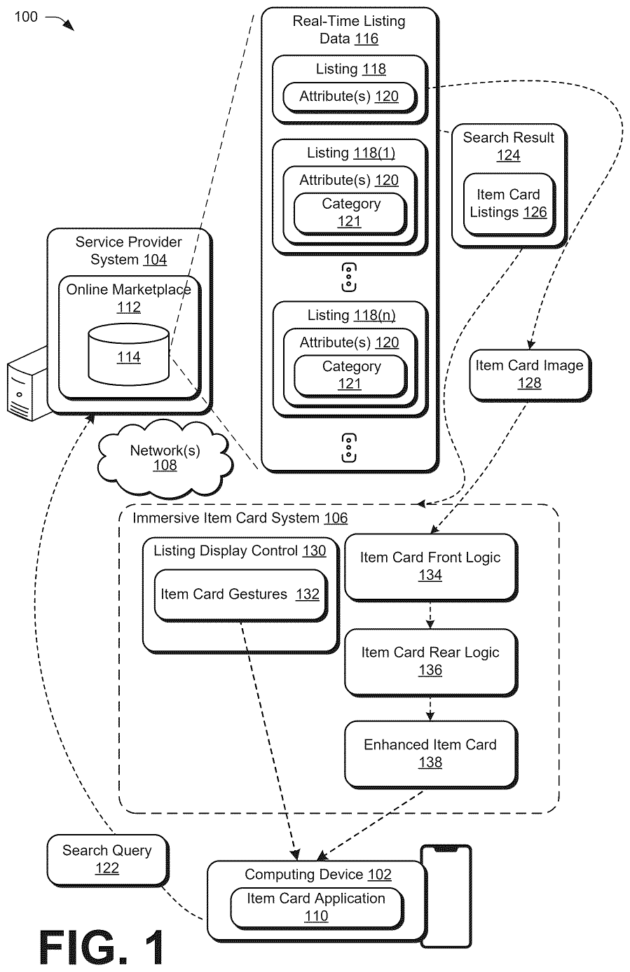

FIG. 1 is an illustration of an environment 100 in an example implementation that is operable to employ techniques described herein. The environment 100 includes a computing device 102, a service provider system 104, and an immersive item card system 106. In one or more implementations, the computing device 102, the service provider system 104, and the immersive item card system 106 are communicatively coupled, one to another, via network(s) 108. One example of the network(s) 108 is the Internet, although one or more of the computing device 102, the service provider system 104, and the immersive item card system 106 may be communicatively coupled using one or more different connections or different networks in various implementations.

Although the immersive item card system 106 is depicted in the environment 100 as being separate from the computing device 102 and the service provider system 104, in one or more implementations, an entirety or various portions of the immersive item card system 106 are implemented at or by the computing device 102 and/or the service provider system 104. In at least one implementation, for example, at least a portion of the immersive item card system 106 is implemented by an item card application 110 of the computing device 102 and/or using various resources of the computing device 102, such as hardware resources, an operating system, firmware, and so forth. Alternatively, or additionally, at least a portion of the immersive item card system 106 is implemented by resources (e.g., server-based storage, processing, and so on) of the service provider system 104. Alternatively or additionally, at least a portion of the immersive item card system 106 is implemented using a third-party service, such as a web services platform that provides one or more hardware and/or other computing resources to support provision of services by web service providers.

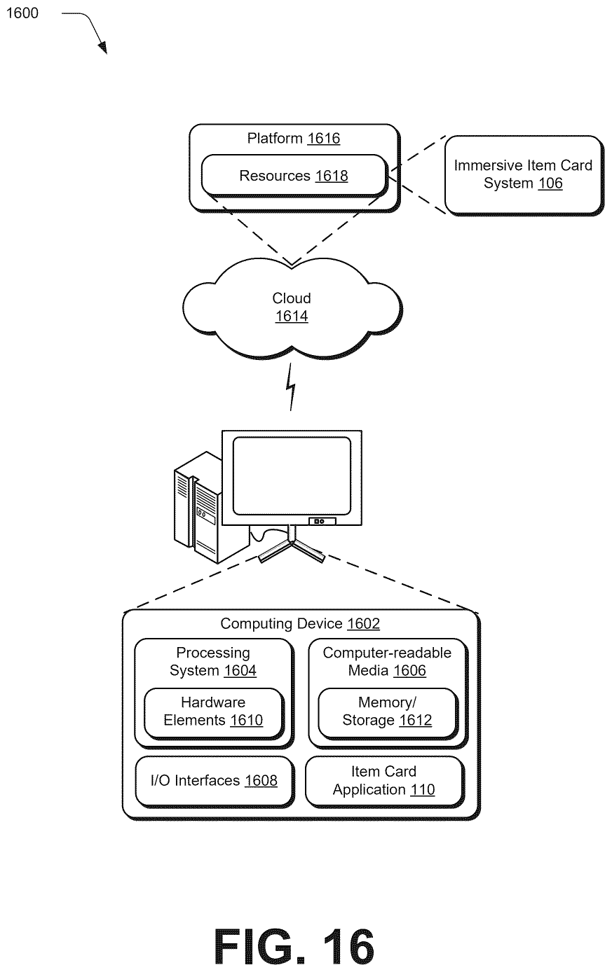

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 16.

In at least one implementation, the item card application 110 supports communication of data across the network(s) 108, such as between the computing device 102 and the service provider system 104 and/or between the computing device 102 and the immersive item card system 106. By supporting such data communication, the item card application 110 provides a respective user of the computing device 102 (and users of other computing devices) access to online marketplace 112. For example, the computing device 102 receives data from the service provider system 104. Based on the received data, the item card application 110 causes various systems of the computing device 102 to output user interfaces of the online marketplace 112, such as by displaying user interfaces via display devices and/or making accessible voice-based user interfaces.

Through interaction of a user with the computing device 102, the item card application 110 receives user input via one or more user interfaces of the online marketplace 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the item card application 110 is a browser, which is operable to navigate to a website of the online marketplace 112, display pages of the website, and facilitate user interaction with web pages of the online marketplace 112's website. Another example of the item card application 110 is a web-based computer application of the online marketplace 112, such as a mobile application or a desktop application. The item card application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings for items and to expose those listings (e.g., publish them) across the network(s) 108 to one or more computing devices, including to the computing device 102. For example, the online marketplace 112 may generate listings for items for sale and expose those listings to computing devices, such that users of the computing devices can interact with the listings via user interfaces to initiate transactions (e.g., purchases, add to wish lists, share, and so on) in relation to the respective item or items of the listings. In accordance with the described techniques, the online marketplace 112 is configured to generate listings for one or more types of physical goods or property (e.g., clothing and/or clothing accessories, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network(s) 108, and blockchain backed assets (e.g., non-fungible tokens (NFTs)), to name just a few.

In the illustrated environment 100, the online marketplace 112 includes storage device 114, which is depicted maintaining real-time listing data 116. The real-time listing data 116 includes listings of the online marketplace 112, one example of which is listing 118. Other examples of such listings include listing 118(1) and listing 118(n), where ‘n’ represents any integer number greater than or equal to 2. The real-time listing data 116 is depicted with ellipses to indicate the existence of more listings than the listing 118, the listing 118(1), and the listing 118(n). A category 121 the item in the listing 118 may be an attribute 120 of the listing 118.

The storage device 114 may represent one or more databases and/or other types of storage capable of storing the real-time listing data 116. Examples of the storage device 114 include, but are not limited to, mass storage and virtual storage. In one or more implementations, for example, the storage device 114 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed to such an account or tracked as a user with an account.

In at least some scenarios, but for the provision of accounts and system guardrails implemented by aspects of the online marketplace 112 (e.g., user interfaces of the item card application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items listed with the online marketplace 112 (e.g., the items that those users decide to list through the online marketplace 112) than the company associated with the online marketplace 112 (or its employees or agents).

Users that cause items to be listed on the online marketplace 112 may be referred to as “sellers,” whereas users that purchase or otherwise obtain items listed on the online marketplace 112 via its listings may be referred to as “buyers.” Sellers and buyers both interact with user interfaces of the online marketplace 112 (e.g., via the item card application 110) to perform the desired functionality. In addition, an individual user of the online marketplace 112 can interact via the interfaces to be both a seller and a buyer on the online marketplace 112, such as by interacting with the user interfaces to have caused one or more items to be listed on the online marketplace 112 and by interacting with the user interfaces to purchase one or more items from the listings of the online marketplace 112.

A user that is a seller, for instance, may interact with one or more user interfaces of the online marketplace 112 (e.g., output via the item card application 110) to provide information about one or more items which the user is causing to be listed on the online marketplace 112. Such user interfaces may include prompts that instruct, or guide, users that are sellers to provide various information about items being listed. Examples of information that such interfaces prompt sellers for and that those users provide include but are not limited a title, description (of the item), one or more prices (e.g., to purchase the item now and/or a minimum starting bid for the item), brand information, size, year, color(s), shipping information (e.g., cost and/or types available), delivery information, return information, payment information, images, videos, models, authenticity information, item history (e.g., chain of custody), and condition (of the item), to name a few.

One or more portions of such information may be referred to herein as “attributes” of the listing. For example, a title of the listing may be an attribute of the listing, a description of the item being listed may be an attribute of the listing, one or more images uploaded or selected for the listing may be one or more attributes of the listing, color(s) of the item may be an attribute of the listing, a category of the item may be an attribute of the listing, and so forth.

In one or more implementations, the online marketplace 112 saves and maintains the input information for a listing in the storage device 114 in fields of a data structure or data record populated for the listing, where a given field and the information populated and maintained for the given field correspond to a particular attribute of the listing. For instance, a ‘title’ field of such a data structure or data record may be populated with information (e.g., text) input into a user interface by a seller of a listing. The title field and the information input by the user as the title of the listing correspond to an attribute of the listing, e.g., a title attribute. In one or more implementations, one or more of the attributes of a listing may be derived and then populated by the online marketplace 112, such as by the online marketplace 112 processing one or more portions of the information input by a user to populate one or more respective attributes of the listing.

A user that is a seller, for instance, may interact with one or more user interfaces of the online marketplace 112 (e.g., output via the item card application 110) to provide information about one or more items which the user is causing to be listed on the online marketplace 112. Additionally, a user of the item card application 110, that is acting as a buyer or simply searching the online marketplace 112, may provide input to issue search requests which query the online marketplace 112 about items (e.g., trading cards) listed in the online marketplace 112, exemplified as a search query 122. The online marketplace 112 may respond to such search queries with search results 124 which may include one or more item card listings 126 - listings for items for which an item card can be generated. Together with the search result 124, or separately, the online marketplace 112 may provide an item card image 128 corresponding to the item card listings 126.

Although generating and presenting immersive item cards is described largely in relation to trading cards in the examples depicted in FIGS. 1-11D, in variations, item cards that provide an immersive experience may be generated and presented for any of a variety of other types of items, examples of which include but art not limited to clothing items, clothing accessories (e.g., hand bags, watches, other jewelry, and so forth), shoes/sneakers, collectibles in addition to trading cards, works of art, electronics, kitchen appliances and accessories, and automotive parts, just to name a few.

The immersive item card system 106 includes a listing display control 130 which instructs the item card application 110 specifically as to control of the display to allow user interaction with virtualized images corresponding to the item card. The listing display control 130 facilitates (e.g., defines inputs and responses to detecting those inputs) item card gestures 132 which are designed to provide a tactile experience for interaction with the item card when displayed at the computing device 102. The immersive item card system 106 is also depicted including item card front logic 134 and item card rear logic 136 which are applied to one or more enhanced item cards, represented here by an enhanced item card 138. The item card front logic 134 defines behaviors for presentation and interaction (along with responses to user inputs) with the front of an item card. The item card rear logic 136 defines behaviors for presentation and interaction (along with responses to user inputs) with the rear of an item card. Alternatively or additionally, the item card front logic 134 and/or the item card rear logic 136 define how and/or are applied to generate the enhanced item card 138, e.g., from real-time listing data 116 corresponding to an item card, such as by using one or more images uploaded for the item card.

Examples of trading cards include, but are not limited to: sports cards, character cards, and the like, some of which may be considered to be collectible items, as well as a market listing itself in the online marketplace 112 of an item being sold, including listing information and the item card image 128 of the item. The item card image 128 includes a front image and may or may not include a rear image. The item card image 128 is processed based on the item card front logic 134 and the item card rear logic 136 to provide the enhanced item card 138 which is operable in accordance with the item card gestures 132. In one or more implementations, for example, one or more image segmentation techniques defined by the item card front logic 134 are applied to at least one item card image 128 to segment the image into multiple segments, which are then converted into multiple layers. The item card front logic 134 may also define or be used to determine a z-ordering or depth of the segments and/or multiple layers to display the layers as part of the enhanced item card 138 so that they appear to be displayed at different depths. For example, the item card front logic 134 may apply one or more image saliency techniques to determine the “important” portions or segments of the image and order the layers or segments for display (e.g., in the z-order) based at least in part on a respective saliency relative to other layers or segments. In one or more implementations, the item card front logic 134 may limit a number of segments into which the item card image 128 is segmented and/or may merge one or more identified segments into a same segment or layer. The enhanced item card 138 is communicated to the item card application 110.

Having considered an example of an environment, consider now a discussion of some example details of the techniques for immersive item cards in accordance with one or more implementations.

### Immersive Item Cards Implementation Details

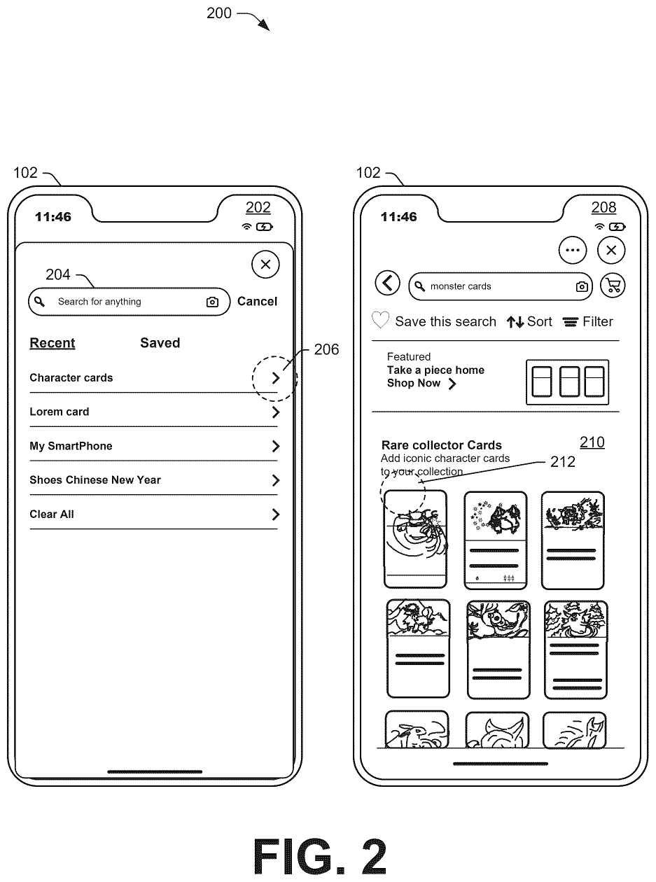

FIG. 2 depicts an example 200 of a user interface for an immersive item card experience.

The illustrated example 200 includes the computing device 102 displaying a listing search user interface 202. The listing search user interface 202 includes a variety of interactive user interface elements with which a user can interact to provide information about an item that the user would like to locate in the online marketplace 112. As noted above, the online marketplace 112 receives input via such interactive elements to specify information to be searched regarding a listing.

In this particular example 200, the user may interact with a search input 204 to specify the search parameters, or as in this present example the user may interact with recent searches, such as by selecting 206 “character cards” to issue the search and to receive the search results as illustrated in the search results user interface 208. The search results user interface 208 can specify various search results, represented here by a list 210 of search results titled “Rare collector Cards”. The user may interact with the search results user interface 208 to select 212 one or more of the item cards returned in the list 210 of the search results.

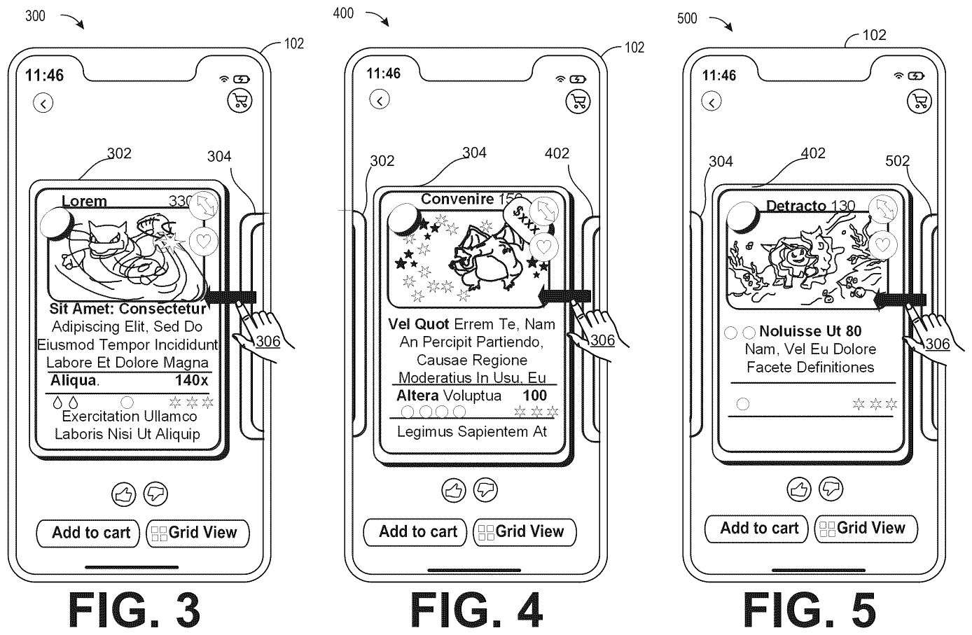

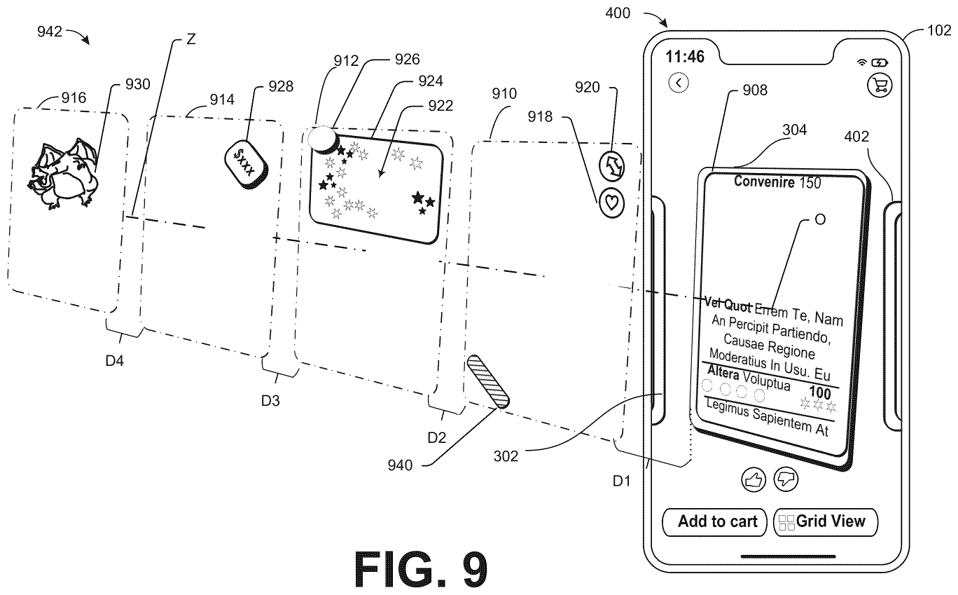

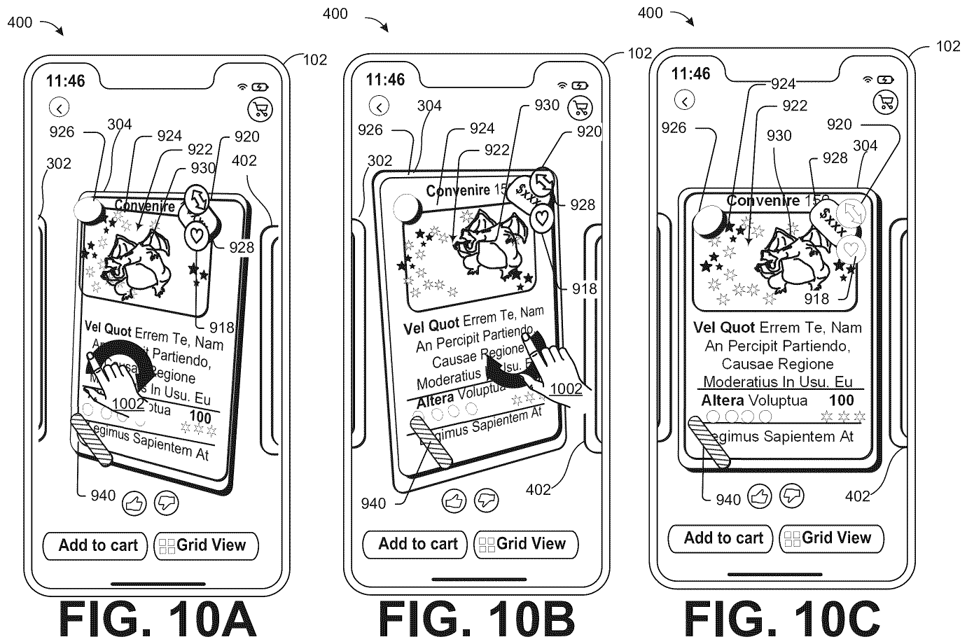

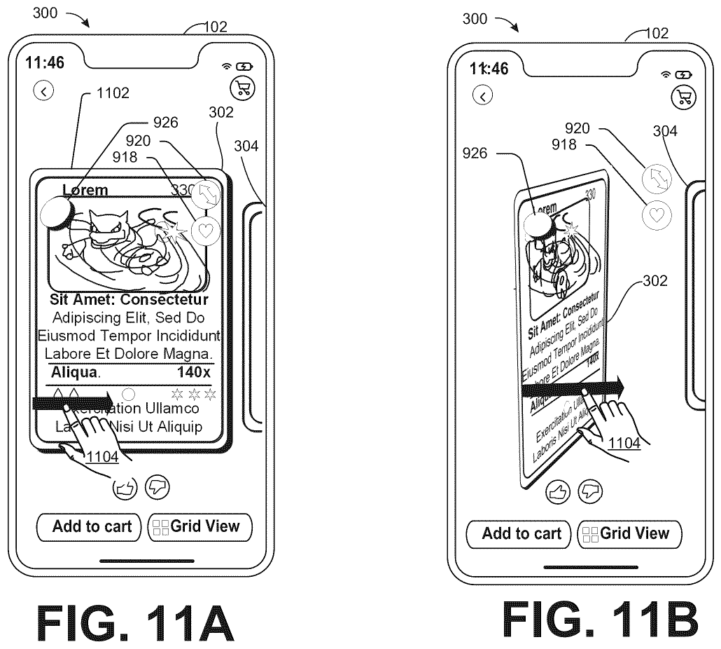

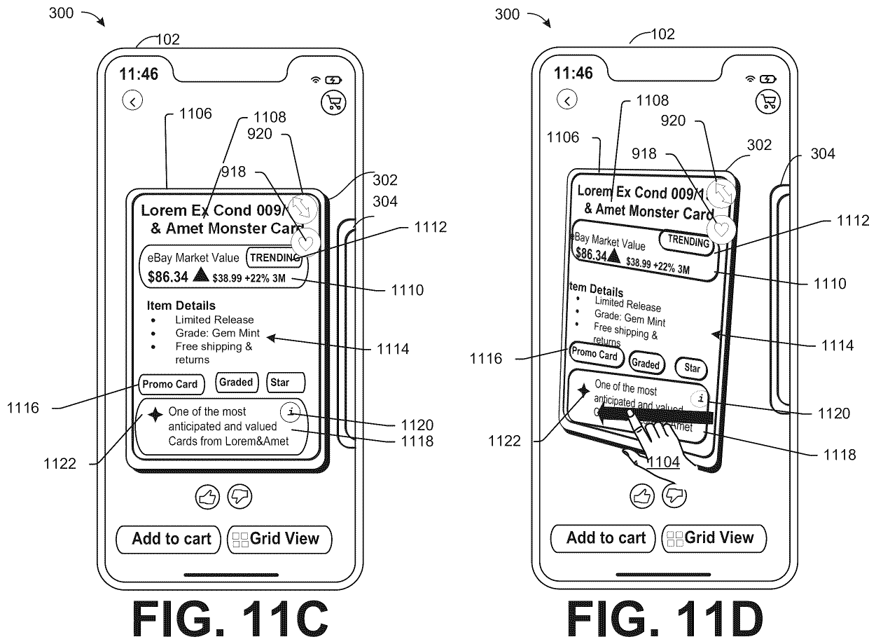

By way of overview, FIG. 3 to FIG. 11A-D illustrate an example immersive item card experience which supports a three-dimensional, tactile interaction with item cards that provides in-depth inspection. An example results-scroll-gesture is illustrated in FIG. 3 to FIG. 8 which depict a sequence of user interfaces that are scrolled through some of the item cards returned in the search results. FIG. 9 illustrates concepts of an enhanced image of an item card front, for the item card of FIG. 4. An example of a 3D-rotation-gesture on the enhanced image of the item card front is illustrated in FIG. 10A to FIG. 10C. An example of a flip-gesture of the enhanced item card of FIG. 3 is depicted in FIG. 11A to FIG. 11D. FIG. 11C illustrates concepts of an item card rear of the enhanced item card. These figures are individually discussed below.

FIG. 3 depicts another example 300 of a user interface for an immersive item card experience. The example 300 of the user interface is displayed in a scenario in which the user has selected a first item card 302 of the item cards returned in the search results. In addition to displaying the current item card, the user interface can at least partially display the preceding item card (if any) and the succeeding item card (if any). In this example, the user interface displays the first item card 302 and partially displays a second item card 304 which is the succeeding item card in the sequence of item cards returned in the search results. A results-scroll-gesture 306 scrolls through the item cards returned in the search results. In this example, the results-scroll-gesture 306 is performed and detected in left or right directions to scroll forward or backward through the item cards in the search results. In at least one variation, the results-scroll-gesture 306 may be performed and detected in other directions to scroll through the item cards in the search results, e.g., up-down. The user in this example has performed a results-scroll-gesture 306 to scroll forward to the next item, e.g., a right-to-left swipe gesture.

FIG. 4 depicts another example 400 of a user interface for an immersive item card experience. The example 400 is displayed in response to the user scrolling forward to the second item card 304. The user interface partially displays the preceding item card, which is the first item card 302, and the succeeding item card, which is a third item card 304 returned in the search results. The results-scroll-gesture 306 scrolls in the left-right direction forward and backward through the item cards. The user in this example performs another results-scroll-gesture 306 to scroll forward to the next item, which is the third item card 304.

FIG. 5 depicts another example 500 of a user interface for an immersive item card experience. The example 500 is displayed in response to the user scrolling forward to the third item card 402. The user interface partially displays the preceding item card, which is the second item card 304, and the succeeding item card, which is a fourth item card 502 returned in the search results. The user in this example performs another results-scroll-gesture 306 to scroll forward to the next item, which is the fourth item card 502.

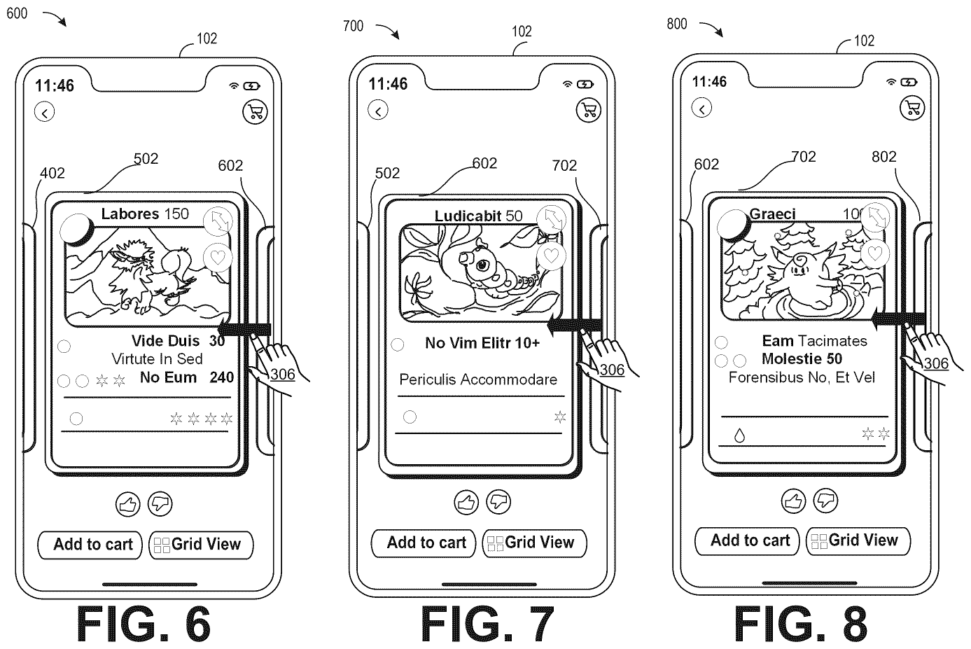

FIG. 6 depicts another example 600 of a user interface for an immersive item card experience. The example 600 is displayed in response to the user scrolling forward to the fourth item card 502. The user interface partially displays the preceding item card, which is the third item card 402, and the succeeding item card, which is a fifth item card 602 returned in the search results. The user in this example performs another results-scroll-gesture 306 to scroll forward to the next item, which is the fifth item card 602.

FIG. 7 depicts another example 700 of a user interface for an immersive item card experience. The example 700 is displayed in response to the user scrolling forward to the fifth item card 602. The user interface partially displays the preceding item card, which is the fourth item card 502, and the succeeding item card, which is a sixth item card 702 returned in the search results. The user in this example performs another results-scroll-gesture 306 to scroll forward to the next item, which is the sixth item card 702.

FIG. 8 depicts another example 800 of a user interface for an immersive item card experience. The example 800 is displayed in response to the user scrolling forward to the sixth item card 702. The user interface partially displays the preceding item card, which is the fifth item card 602, and the succeeding item card, which is a seventh item card 802 returned in the search results. The user in this example may perform another results-scroll-gesture 306 to scroll forward to the next item, which is the seventh item card 802.

Although these examples of FIG. 3 to FIG. 8 illustrate the results-scroll-gesture 306 operated by the user swiping from right to left to scroll forward to a respectively succeeding item card, the results-scroll-gesture 306 may be operated by the user swiping left to right in a reverse direction to scroll backward to a respectively preceding item card. As noted above, in variations, the immersive item card system 106 may enable user input to scroll vertically (e.g., responsive to up-down gestures) rather than or in addition to horizontally.

The gestures discussed herein may be implemented via touch screen techniques, scroll wheel techniques, arrow key techniques, arrow buttons, track pads, voice command, and variations and enhancements thereof.

FIG. 9 depicts an exploded view of another example 400 of the user interface for an immersive item card experience. FIG. 9 illustrates concepts of an enhanced image of an item card front 942, for the second item card 304, shown in FIG. 4. The item card image 128 may be a photograph of a physical item card such as may be uploaded from the computing device 102, or a generic stock image of the same type of item card as would be available from a repository (e.g., public or stock), for example. The item card image 128 of a front of a trading card, which is a two-dimensional image, may be segmented by the item card front logic 134 into two or more layers which are displayed at different depths relative to each other, the layers collectively integrated to form the enhanced image of the item card front 942 displayed on the user interface. In this example, the front of the second item card 304 is segmented into layers including a base layer 908, a first intermediate layer 910, a second intermediate layer 912, a third intermediate layer 914, and a top layer 916, indicated by the dot-dash line. The item card front logic 134 detects edge patterns forming peripheral frames and text to include in the base layer 908. The item card front logic 134 detects user interface command icons 918, 920, which are superimposed as shown in the example 400 of the user interface, to include in the first intermediate layer 910. The item card front logic detects a background picture 922, interior frame 924, and one or more of the informative symbols, medals, and the like 926, to include in the second intermediate layer 912. The item card front logic 134 detects one or more labels such as a price sticker tag 928 superimposed as shown in the example 400 of the user interface to include in the third intermediate layer. The item card front logic 134 detects a main subject such as a character 930 to include in the top layer. Alternatively, or additionally, fewer or more layers may be utilized, and/or the layers may include segments different from those which are described by way of example. Segments which are visible in one of the layers are not visible in the other layers. In one or more implementations, various objects described above as being detected (e.g., the price sticker tag 928) may not be detected as part of the item card image 128 - such items objects may not be present on the physical card captured in the image and/or included in an image received from a repository. Instead, in one or more implementations, those objects may be incorporated into various layers based on the item card front logic 134 and one or more attribute 120 of the respective listing, e.g., a price attribute.

A type of a physical defect, such as a fold, a tear, a scratch, a kink, a scuff, a bend, or the like, which may exist in a physical trading card corresponding to the item card 304, and a location and dimensions thereof in the physical trading card, may be indicated in the attribute 120 of the corresponding listing 118. The item card front logic detects any attribute 120 of the item card listing 118(n) corresponding to the second item card 304 which indicates or which can be processed to detect and indicate the location of one or more physical defects that exist in the corresponding physical trading card, and displays an indication 940 of such a defect. For instance, this indication 940 may highlight a location and dimensions of a defect on the item card in one of the layers, here, in the first intermediate layer 910. Alternatively or additionally, the indication 940 may indicate a type and/or severity of the defect. In one or more implementations, the indication 940 may comprise a 3D representation of the defect, such as by modifying portions of a model of the 3D item card so that when rendered, the 3D item card looks like the actual physical card having the defect. In at least one implementation, the immersive item card system 106 may detect a defect by analyzing the item card image 128 of the card, such as by using one or more image processing techniques trained to identify such defects, e.g., object and/or pattern recognition.

The item card front logic 134 is applied to layers 908, 910, 912, 914, 916, to arrange them in the enhanced item card 138 for display in a perspective view along a Z-axis, indicated by a double dash-dot line with an origin O on the base layer 908, and are separated and spaced apart (in terms of depth) at a distance D1 to D4, respectively, from each other. The distances D1 to D4 between the layers may be the same or may be different from each other. Each of the layers 908, 910, 912, 914, 916 is at a fixed location with respect to the Z-axis and each of the layers has its own depth from the origin O which is fixed with respect to the base layer 908. Consequently, the layers 908, 910, 912, 914, 916 are arranged in a depth-order, superimposed over each other front-to-back, and displayed at different depths from the origin O. The origin O of the Z-axis may be implemented at alternative locations on the user interface.

The end of the Z-axis may be manipulated by the user executing a 3D-rotation-gesture, which achieves a rotatable display on the computing device 102 in response to the end of the Z-axis moving with respect to the origin O, which is fixed on or behind the base layer 908 or on the computing device 102. As a consequence, the layers 908, 910, 912, 914, 916 can be moved on the computing device 102, individually, at the respective depth from the origin O, to follow the Z-axis to which they are fixed as the Z-axis is manipulated leftward, rightward, upward, and/or downward by the user executing a 3D-rotation-gesture. As the Z-axis is manipulated, a tactile effect is achieved of a movable three-dimensional (3D) perspective view, and portions of lower layers which are arranged in depth-order will be covered or uncovered as the layers above are moved, encouraging closer inspection by the user. The layers 908, 910, 912, 914, 916 which are fixed to the Z-axis and displayed in depth-order along the Z-axis collectively provide the enhanced image of the item card front 942 when displayed on the user interface.

FIG. 10A to FIG. 10C depict another example 400 of the user interface for an immersive item card experience. An example of a 3D-rotation-gesture 1002 on the enhanced image of the item card front is illustrated in FIG. 10A and FIG. 10B.

In FIG. 10A, the 3D-rotation-gesture 1002 is rotated leftward and upward, and the perspective display of the layers skews left and up. The layers, which are displayed at distances from each other and at different depths from the origin O, appear to float in relation to each other synchronously with changes to the Z-axis, in relation to a movable 3D perspective view of the item card front 942. In other words, the floating and rotating presentation of the layers may be referred to as providing a parallax effect of the item card front. In FIG. 10B, the 3D-rotation-gesture 1002 is rotated rightward and upward, and the perspective display of the layers skews rightward and upward. By moving the perspective display of the layers to follow the changes in the Z-axis, the displayed features in the upper layers appear to hover over the features in layers below.

As examples, the character 930 in the top layer appears to the left and down in FIG. 10A and to the right and upward in FIG. 10B in relation to the background picture 922 and the interior frame 924 in the second intermediate layer. The price sticker tag 928, in the third intermediate layer, appears leftward and downward in FIG. 10A and to the right and upward in FIG. 10B in relation to the user interface command icons 918, 920 in the first intermediate layer 910.

In FIG. 10C, the 3D-rotation-gesture 1002 has terminated, the Z-axis of the enhanced item card is returned to a default position (e.g., originating substantially at a back of the phone and extending toward a viewer of the phone), and the segmented layers of the enhanced item card are returned to their default positions. In FIG. 10C, the indication 940 that highlights the location on the item card of the physical defect, which was added by the item card front logic 134, is displayed.

FIG. 11A to FIG. 11D depict another example 300 of the user interface for an immersive item card experience. FIG. 11A to FIG. 11D illustrate an item card front 1102 being rotated by a flip-gesture 1104 to and from an item card rear 1106, using the enhanced item card as depicted in FIG. 3. FIG. 11C illustrates additional concepts of the item card rear 1106.

In FIG. 11A, the flip-gesture 1104 is in a left-right direction which is distinguished from the results-scroll-gesture, for example, by starting at a different location on the computing device 102, such as in a periphery of the item card 302 which is displayed. Alternatively or in addition, a flip gesture may be distinguished from a scroll gesture based on a detected speed of a swipe gesture, e.g., a faster speed of a swipe gesture may cause the gesture to be detected as a scroll gesture causing the user interface to scroll through the results whereas a slower speed of a swipe gesture may cause the gesture to be detected as a flip gesture or a gesture to rotate a front of the item card presenting the layers in a manner that they appear to float which may be referred to as a “parallax” effect. Alternatively, or in addition, a flip gesture may be distinguished from a scroll gesture based on gestures or interactions detected using one or more gyroscopes (and associated technology) of the computing device 102. Using a gyroscope, for instance, the computing device 102 can detect whether a user tilts the computing device 102 in various directions, such as tilting the computing device 102 to the left or to the right. Responsive to detecting, using the gyroscope, that a user tilts the computing device 102 in one or more predefined directions, in one or more implementations, the application may flip the immersive item card from a front to a rear or vice versa in the user interface. In other words, a flip gesture may be received by detecting that the computing device 102 has been tilted. A flip gesture may be detected in any of a variety of other ways in accordance with the described techniques.

In response to the flip-gesture 1104, the item card 302 as displayed is rotated in a front-back rotation direction from the item card front 1102 to the item card rear 1106, preferably in correspondence to the direction of the flip-gesture 1104. The flip-gesture 1104 also operates to rotate the item card 302 from the item card rear 1106 to the item card front 1102. Displayed items such as the user interface command icons 918, 920 remain stationary, as they are not part of the item card 302. Utilization of a display of the item card 302 in perspective view as illustrated in FIG. 11B and FIG. 11D while performing the front-back rotation as described achieves a tactile effect that the flip-gesture 1104 physically moves the item card 302.

As further illustrated in FIG. 11C, information may physically exist on the rear of the real-world item card and thus may be reflected in an image of a rear of the item card is replaced or enhanced in the enhanced item card 138 rear which is displayed on the user interface. The item card is physically a two-dimensional object with information physically existing on a rear of the item card. The item card rear logic 136 prepares the item card rear 1106. The item card rear logic 136 retrieves listing data 116 corresponding to the listing 118 of the item card, including listing information 1108 of the listing 118, real-time trending information 1110 for additional listings of the trading card, a trending confirmation indication 1112, item details 1114 in the listing 118, additional information 1116 related to the corresponding physical trading card such as whether the trading card is promotional, graded, or ranked, an artificial intelligence-generated description 1118 of the respective item (e.g., the trading card), information 1120 regarding the artificial intelligence-generated description 1118, and an artificial-intelligence-enhancement indication 1122.

In one or more implementations, the real-time trending information 1110 is based on an analysis of market information for additional listings of a same or similar item, and offers a more engaging and visually stimulating experience in a three-dimensional, tactile format. The immersive item card system 106 may continue providing the real-time trending information to the computing device 102 for which the display of the item card rear 1106 is adapted to continue to display the real-time trending information 1110 as it is received. The item details 1114, additional information 1116, and/or the artificial intelligence-generated description 1118 may be provided in a scrollable interactive user interface element that provides a variety of information.

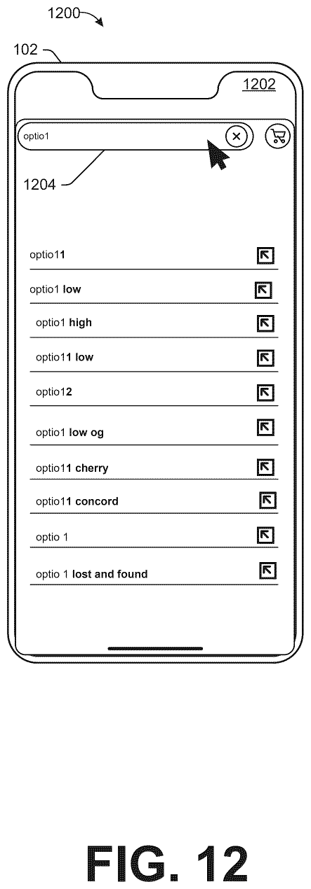

FIG. 12 depicts another example 1200 of a user interface for an immersive item card experience. The illustrated example 1200 includes the computing device 102 displaying a listing search user interface 1202. The listing search user interface 1202 includes a variety of interactive user interface elements to provide query terms that the user would like to locate in the online marketplace 112. In this particular example 1200, the user may interact with a search input 1204 to specify the search parameters, such as by inputting “optio1”, which results in the computing device 102 receiving search results.

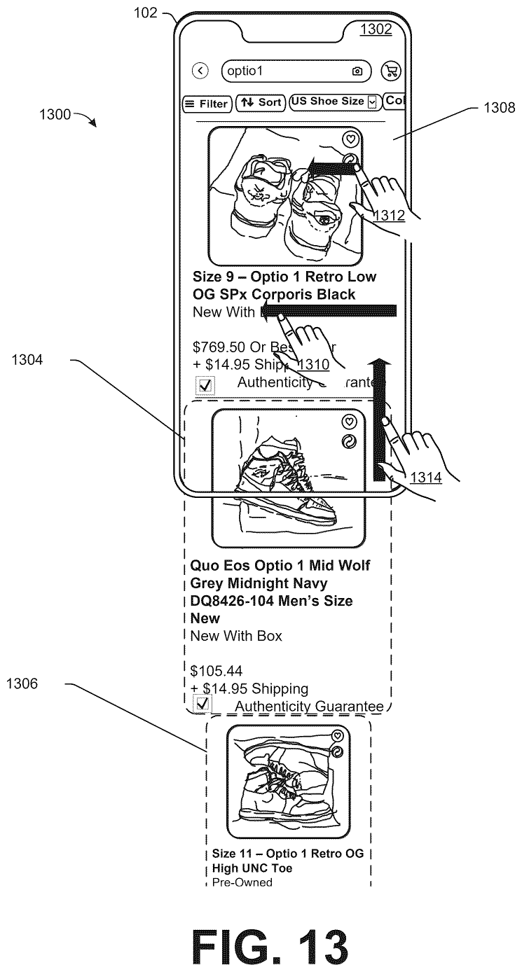

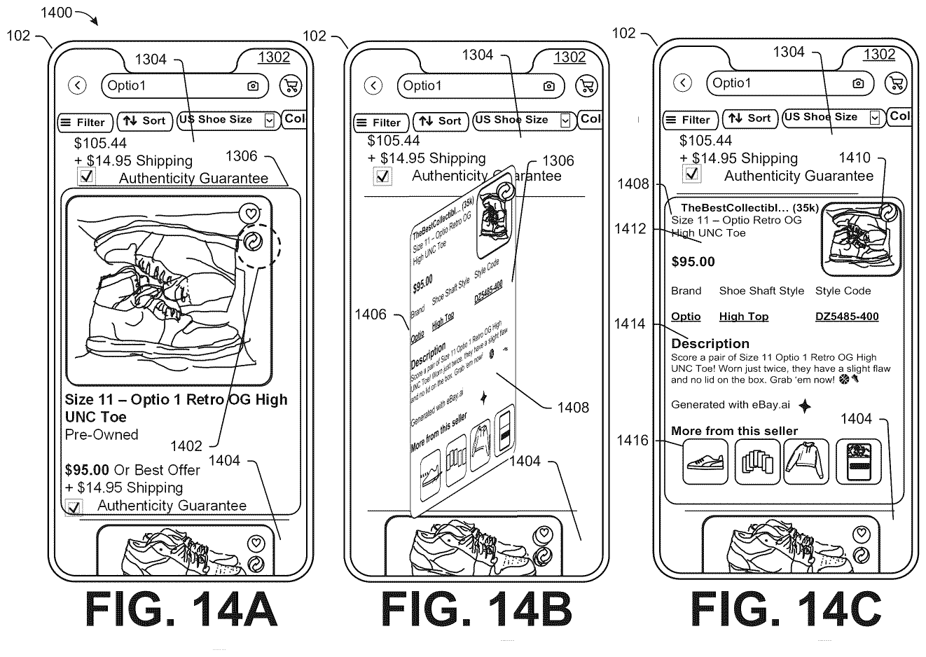

FIG. 13 depicts another example 1300 of a user interface for an immersive item card experience. The search results are displayed as illustrated in a search results user interface 1302. The search results user interface 1302 can scroll through a listing of item cards 1304, 1306, 1308, corresponding to shoes listed in the online marketplace 112, returned in the search results. A flip-gesture 1310 can cause the rotatable display to perform a front-to-back rotation of the item card 1308. A listing-scroll-gesture 1312 is provided to scroll through multiple images that correspond to one of the listings, here illustrated as a short left-right gesture starting on one of the displayed images of the item card 1308. The flip-gesture 1310 is illustrated as starting at a different location on the computing device 102 such as at a periphery of the item card 1308 in comparison to a start location of the listing-scroll-gesture 1312. A results-scroll-gesture 1314 scrolls through the item cards returned in the search results. In this example, the results-scroll-gesture 1314 is in an up-down direction to scroll upward and downward through a “carousel” of the item cards provided in the search results. In this example, a direction of the flip-gesture 1310, that causes the rotatable display to perform the front-back rotation of the enhanced item card, is perpendicular to a direction of the results-scroll-gesture.

FIG. 14A to FIG. 14C depict another example 1400 of the user interface for an immersive item card experience. FIG. 14A to FIG. 14C illustrate aspects of the rotatable display performing a front-back rotation of the enhanced item card. In the example of FIG. 13, the front-back rotation is responsive to the flip-gesture 1310. As an alternative or in addition thereto in the example of FIG. 14A, the front-back rotation is responsive to selection by a user of a flip-icon 1402. The item card 1306 that is rotated remains in context in the results listing which concurrently maintains a display of a portion of the preceding item card 1304 and the succeeding item card 1404 without being flipped. In the front-back rotation, the item card 1306 as displayed is rotated in a front-back rotation direction from an item card front 1406 to an item card rear 1408.

Utilization of a display of the item card 1306 in perspective view as illustrated in FIG. 14B while performing the front-back rotation achieves a simulation that the item card 1306 is a three-dimensional object with a front and rear, and achieves a tactile effect that the flip-gesture 1310 or the flip-icon 1402 physically causes the item card 1306 to be flipped.

The item card front logic 134 prepares the item card front 1406. The item card rear logic 136 prepares the item card rear 1408 shown in FIG. 14C from the listing 118 corresponding to the item card. The item card rear 1408 may include a reduced-size display 1410 of the item card image 128, a title and item details 1412 in the listing 118, an artificial intelligence-generated description 1414 of the item card, and additional seller items 1416. The artificial intelligence-generated description 1414 is based on an analysis of the listing 118 and offers a more engaging and visually stimulating experience in a three-dimensional, tactile format.

Having discussed exemplary details of immersive item cards, consider now some examples of procedures to illustrate additional aspects of the techniques.

### Example Procedures

This section describes examples of procedures for immersive item cards. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

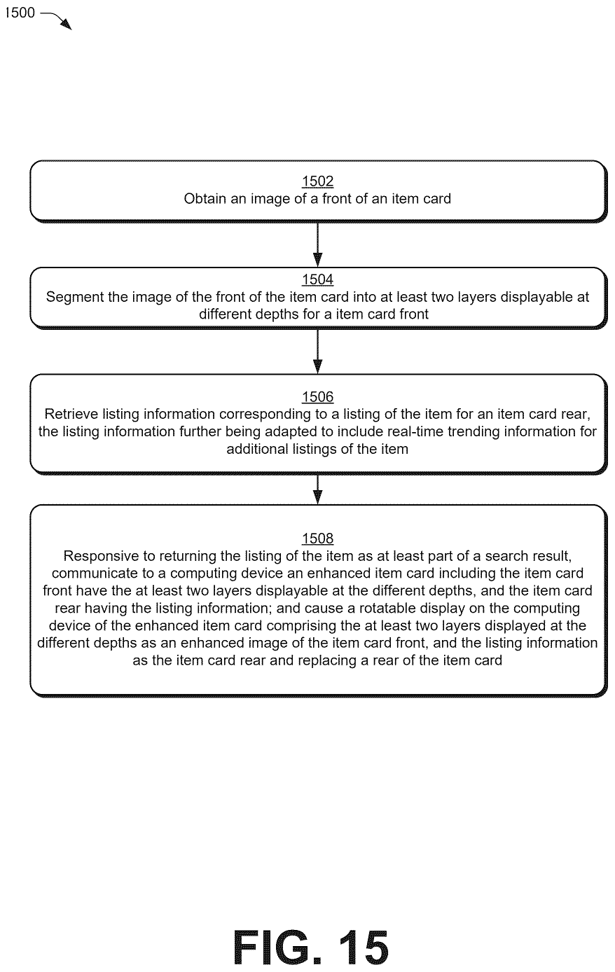

FIG. 15 depicts a procedure 1500 in an example implementation of immersive item cards.

An image of a front of an item card is obtained (block 1502). By way of example, the immersive item card system 106 receives the listing 118, which includes the item card image 128 for an item listed by the listing 118.

The image of the front of the item card is segmented into at least two layers displayable at different depths for an item card front (block 1504). By way of example, the immersive item card system 106 executes item card front logic 134 which segments the front image included the item card image 128 into two or more layers 908, 910, 912, 914, 916, which are described to be displayed at the computing device 102 in the item card application 110 at the different depths with respect to the base layer 908, in accordance with the principles discussed herein.

The listing information corresponding to a listing of the item is retrieved for a trading card rear, and the listing information on the trading card rear is further adapted to include real-time trending information for additional listings of the item (block 1506). By way of example, the immersive item card system 106 executes the item card rear logic 136 which retrieves the listing information for the listing, and retrieves real-time trending information for additional listings of the item such as the same genre, possibly augmented by artificial intelligence analysis, which are described to be displayed at the computing device 102 in the item card application 110 as the item card rear, to substitute for or to augment a stored image of the rear of the item card obtained from the real-time listing data 116, or to behave in the item card application 110 as the rear of the item card if there is no rear such as for a simple listing 118 of an item.

In response to returning the listing of the item having the associated item card as at least part of a search result, an enhanced item card is communicated to a computing device. The enhanced item card includes the item card front having the at least two layers displayable at the different depths, and the item card rear having the listing information; and a rotatable display is caused on the computing device, of the enhanced item card including the at least two layers displayed at the different depths as an enhanced image of the item card front, and the listing information as the item card rear 1106 (block 1508). By way of example, in response to the search result 124 including the listing of the item card being returned to the immersive item card system 106, the immersive item card system 106 obtains the enhanced item card corresponding to the item and which includes the enhanced image of the item card front 1102, including the layers of the item card front 942, and the item card rear 1106 including the listing information 1108, real-time trending information 1110 of like items based on, for example, analysis of relevant information in the online marketplace 112, and artificial intelligence-generated description 1118 generated in real-time as corresponding to the item card.

In some aspects, the techniques described herein relate to a method of providing an immersive trading card experience, including: obtaining an image of a front of a trading card; segmenting the image of the front of the trading card into at least two layers displayable at different depths for a trading card front; retrieving listing information corresponding to a listing of the trading card for a trading card rear, the listing information further being adapted to include real-time trending information for additional listings of the trading card; and responsive to returning the listing of the trading card as at least part of a search result: communicating to a computing device an enhanced trading card including the trading card front having the at least two layers displayable at the different depths, and the trading card rear having the listing information; and causing a rotatable display on the computing device of the enhanced trading card including the at least two layers displayed at the different depths as an enhanced image of the trading card front, and the listing information as the trading card rear and replacing a rear of the trading card.

In some aspects, the techniques described herein relate to a method, wherein in the enhanced image of the trading card front in the rotatable display, the at least two layers displayed at the different depths are superimposed on each other, arranged in a depth-order, and are separated by a distance causing the at least two layers to float relative to a movable three-dimensional (3D) perspective view of the trading card front.

In some aspects, the techniques described herein relate to a method, further including causing the computing device to respond to gestures including a results-scroll-gesture that scrolls among a plurality of trading cards included in the search result, a flip-gesture that performs a front-back rotation of the enhanced trading card between the trading card front and the trading card rear, and a 3D-rotation-gesture that causes the at least two layers displayed at the different depths in the enhanced image of the trading card front in the rotatable display to float in correspondence to a movable 3D perspective view of the trading card front.

In some aspects, the techniques described herein relate to a method, further including causing the rotatable display to facilitate display of the listing information as the trading card rear while at least one additional trading card included in the search result is concurrently displayed.

In some aspects, the techniques described herein relate to a method, further including facilitating the computing device to respond to a listing-scroll-gesture that causes the rotatable display to scroll through a plurality of images corresponding to the listing of the trading card, and to a flip-gesture perpendicular to a direction of a results-scroll-gesture that scrolls among a plurality of items included in the search result or to a flip-icon that causes the rotatable display to perform a front-back rotation of the enhanced trading card.

In some aspects, the techniques described herein relate to a method, further including facilitating the computing device to provide a search result display which lists items included in the search result while maintaining the rotatable display in a context of the search result display.

In some aspects, the techniques described herein relate to a method, further including facilitating the computing device to provide an indication, superimposed on the enhanced trading card, that highlights at least one physical defect existing in the trading card.

In some aspects, the techniques described herein relate to a method, wherein the at least one physical defect which is indicated includes one or more of a fold, a tear, a scratch, a kink, a scuff, and a bend physically existing in the trading card.

In some aspects, the techniques described herein relate to a method, wherein the trading card is a sports trading card, and the method further includes including information physically existing on a rear of the sports trading card in the listing information provided to the computing device to replace the rear of the trading card as the trading card rear.

In some aspects, the techniques described herein relate to a system including: one or more processors; and memory storing instructions that, when executed by the one or more processors, cause the system to: obtain an image of a front of a trading card; segment the image of the front of the trading card into at least two layers displayable at different depths for a trading card front; retrieve listing information corresponding to a listing of the trading card for a trading card rear, the listing information further being adapted to include real-time trending information for additional listings of the trading card; and responsive to returning the listing of the trading card as at least part of a search result: communicate to a computing device an enhanced trading card including the trading card front having the at least two layers displayable at the different depths, and the trading card rear having the listing information; and cause a rotatable display on the computing device of the enhanced trading card including the at least two layers displayed at the different depths as an enhanced image of the trading card front, and the listing information as the trading card rear and replacing a rear of the trading card.

In some aspects, the techniques described herein relate to a system, wherein in the enhanced image of the trading card front in the rotatable display, the at least two layers displayed at the different depths are superimposed on each other, arranged in a depth-order, and are separated by a distance causing the at least two layers to float relative to a movable three-dimensional (3D) perspective view of the trading card front.

In some aspects, the techniques described herein relate to a system, wherein the instructions further cause the computing device to respond to gestures including a results-scroll-gesture that scrolls among a plurality of trading cards included in the search result, a flip-gesture that performs a front-back rotation of the enhanced trading card between the trading card front and the trading card rear, and a 3D-rotation-gesture that causes the at least two layers displayed at the different depths in the enhanced image of the trading card front in the rotatable display to float in correspondence to a movable 3D perspective view of the trading card front.

In some aspects, the techniques described herein relate to a system, wherein the instructions further cause the rotatable display to facilitate display of the listing information as the trading card rear while at least one additional trading card included in the search result is concurrently displayed.

In some aspects, the techniques described herein relate to a system, wherein the instructions further cause the computing device to respond to a listing-scroll-gesture that causes the rotatable display to scroll through a plurality of images corresponding to the listing of the trading card, and to a flip-gesture perpendicular to a direction of a results-scroll-gesture that scrolls among a plurality of items included in the search result or to a flip-icon that causes the rotatable display to perform a front-back rotation of the enhanced trading card.

In some aspects, the techniques described herein relate to a system, wherein the instructions further cause the computing device to provide a search result display which lists items included in the search result while maintaining the rotatable display in a context of the search result display.

In some aspects, the techniques described herein relate to a system, wherein the instructions further cause the computing device to provide an indication, superimposed on the enhanced trading card, that highlights at least one physical defect existing in the trading card.

In some aspects, the techniques described herein relate to a system, wherein the at least one physical defect which is indicated includes one or more of a fold, a tear, a scratch, a kink, a scuff, and a bend physically existing in the trading card.

In some aspects, the techniques described herein relate to a system, wherein the trading card is a sports trading card, and wherein the instructions further cause information physically existing on a rear of the sports trading card in the listing information provided to the computing device to replace the rear of the trading card as the trading card rear.

In some aspects, the techniques described herein relate to a non-transitory computer-readable storage medium storing instructions that, when executed by one or more processors, cause the one or more processors to perform operations including: obtaining an image of a front of a trading card; segmenting the image of the front of the trading card into at least two layers displayable at different depths for a trading card front; retrieving listing information corresponding to a listing of the trading card for a trading card rear, the listing information further being adapted to include real-time trending information for additional listings of the trading card; and responsive to returning the listing of the trading card as at least part of a search result: communicating to a computing device an enhanced trading card including the trading card front having the at least two layers displayable at the different depths, and the trading card rear having the listing information; and causing a rotatable display on the computing device of the enhanced trading card including the at least two layers displayed at the different depths as an enhanced image of the trading card front, and the listing information as the trading card rear and replacing a rear of the trading card.

In some aspects, the techniques described herein relate to a non-transitory computer-readable storage medium, wherein in the enhanced image of the trading card front in the rotatable display, the at least two layers displayed at the different depths are superimposed on each other, arranged in a depth-order, and are separated by a distance causing the at least two layers to float relative to a movable three-dimensional (3D) perspective view of the trading card front.

Having described examples of procedures in accordance with one or more implementations, consider now an example of a system and device that can be utilized to implement the various techniques described herein.

### Example System and Device

FIG. 16 illustrates an example of a system generally at 1600 that includes an example of a computing device 1602 that is representative of one or more computing systems and/or devices that may implement the various techniques described herein. This is illustrated through inclusion of the item card application 110 and the immersive item card system 106. The computing device 1602 may be, for example, a server of a service provider, a device associated with a client (e.g., a client device), an on-chip system, and/or any other suitable computing device or computing system.

The example computing device 1602 as illustrated includes a processing system 1604, one or more computer-readable media 1606, and one or more input/output interface(s) 1608 that are communicatively coupled, one to another. Although not shown, the computing device 1602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1604 is representative of functionality to perform one or more operations using hardware. Accordingly, the processing system 1604 is illustrated as including hardware elements 1610 that may be configured as processors, functional blocks, and so forth. This may include implementation in hardware as an application specific integrated circuit or other logic device formed using one or more semiconductors. The hardware elements 1610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1606 is illustrated as including memory/storage 1612. The memory/storage 1612 represents memory/storage capacity associated with one or more computer-readable media. The memory/storage 1612 may include volatile media (such as random-access memory (RAM)) and/or nonvolatile media (such as read only memory (ROM), Flash memory, optical disks, magnetic disks, and so forth). The memory/storage 1612 may include fixed media (e.g., RAM, ROM, a fixed hard drive, and so on) as well as removable media (e.g., Flash memory, a removable hard drive, an optical disc, and so forth). The computer-readable media 1606 may be configured in a variety of other ways as further described below.

Input/output interface(s) 1608 are representative of functionality to allow a user to enter commands and information to computing device 1602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1610 and computer-readable media 1606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1610. The computing device 1602 may be configured to implement particular instructions and/or functions corresponding to the software and/or hardware modules. Accordingly, implementation of a module that is executable by the computing device 1602 as software may be achieved at least partially in hardware, e.g., through use of computer-readable storage media and/or hardware elements 1610 of the processing system 1604. The instructions and/or functions may be executable/operable by one or more articles of manufacture (for example, one or more computing devices 1602 and/or processing systems 1604) to implement techniques, modules, and examples described herein.

The techniques described herein may be supported by various configurations of the computing device 1602 and are not limited to the specific examples of the techniques described herein. This functionality may also be implemented all or in part through use of a distributed system, such as over a “cloud” 1614 via a platform 1616 as described below.

The cloud 1614 includes and/or is representative of a platform 1616 for resources 1618. The platform 1616 abstracts underlying functionality of hardware (e.g., servers) and software resources of the cloud 1614. The resources 1618 may include applications and/or data that can be utilized while computer processing is executed on servers that are remote from the computing device 1602. Resources 1618 can also include services provided over the Internet and/or through a subscriber network, such as a cellular or Wi-Fi network.

The platform 1616 may abstract resources and functions to connect the computing device 1602 with other computing devices. The platform 1616 may also serve to abstract scaling of resources to provide a corresponding level of scale to encountered demand for the resources 1618 that are implemented via the platform 1616. Accordingly, in an interconnected device embodiment, implementation of functionality described herein may be distributed throughout the system 1600. For example, the functionality may be implemented in part on the computing device 1602 as well as via the platform 1616 that abstracts the functionality of the cloud 1614.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method of providing an immersive trading card experience, comprising:
obtaining an image of a front of a trading card;
segmenting the image of the front of the trading card into at least two layers displayable at different depths for a trading card front;
retrieving listing information corresponding to a listing of the trading card for a trading card rear, the listing information further being adapted to include real-time trending information for additional listings of the trading card; and
responsive to returning the listing of the trading card as at least part of a search result:
communicating to a computing device an enhanced trading card including the trading card front having the at least two layers displayable at the different depths, and the trading card rear having the listing information; and
causing a rotatable display on the computing device of the enhanced trading card comprising the at least two layers displayed at the different depths as an enhanced image of the trading card front, and the listing information as the trading card rear and replacing a rear of the trading card.

2. The method of claim 1, wherein in the enhanced image of the trading card front in the rotatable display, the at least two layers displayed at the different depths are superimposed on each other, arranged in a depth-order, and are separated by a distance causing the at least two layers to float relative to a movable three-dimensional (3D) perspective view of the trading card front.

3. The method of claim 1, further comprising causing the computing device to respond to gestures including a results-scroll-gesture that scrolls among a plurality of trading cards included in the search result, a flip-gesture that performs a front-back rotation of the enhanced trading card between the trading card front and the trading card rear, and a 3D-rotation-gesture that causes the at least two layers displayed at the different depths in the enhanced image of the trading card front in the rotatable display to float in correspondence to a movable 3D perspective view of the trading card front.

4. The method of claim 1, further comprising causing the rotatable display to facilitate display of the listing information as the trading card rear while at least one additional trading card included in the search result is concurrently displayed.

5. The method of claim 1, further comprising facilitating the computing device to respond to a listing-scroll-gesture that causes the rotatable display to scroll through a plurality of images corresponding to the listing of the trading card, and to a flip-gesture perpendicular to a direction of a results-scroll-gesture that scrolls among a plurality of items included in the search result or to a flip-icon that causes the rotatable display to perform a front-back rotation of the enhanced trading card.

6. The method of claim 1, further comprising facilitating the computing device to provide a search result display which lists items included in the search result while maintaining the rotatable display in a context of the search result display.

7. The method of claim 1, further comprising facilitating the computing device to provide an indication, superimposed on the enhanced trading card, that highlights at least one physical defect existing in the trading card.

8. The method of claim 7, wherein the at least one physical defect which is indicated includes one or more of a fold, a tear, a scratch, a kink, a scuff, and a bend physically existing in the trading card.

9. The method of claim 1, wherein the trading card is a sports trading card, and the method further comprises including information physically existing on a rear of the sports trading card in the listing information provided to the computing device to replace the rear of the trading card as the trading card rear.

10. A system comprising:
one or more processors; and
memory storing instructions that, when executed by the one or more processors, cause the system to:
obtain an image of a front of a trading card;
segment the image of the front of the trading card into at least two layers displayable at different depths for a trading card front;
retrieve listing information corresponding to a listing of the trading card for a trading card rear, the listing information further being adapted to include real-time trending information for additional listings of the trading card; and
responsive to returning the listing of the trading card as at least part of a search result:
communicate to a computing device an enhanced trading card including the trading card front having the at least two layers displayable at the different depths, and the trading card rear having the listing information; and
cause a rotatable display on the computing device of the enhanced trading card comprising the at least two layers displayed at the different depths as an enhanced image of the trading card front, and the listing information as the trading card rear and replacing a rear of the trading card.

11. The system of claim 10, wherein in the enhanced image of the trading card front in the rotatable display, the at least two layers displayed at the different depths are superimposed on each other, arranged in a depth-order, and are separated by a distance causing the at least two layers to float relative to a movable three-dimensional (3D) perspective view of the trading card front.

12. The system of claim 10, wherein the instructions further cause the computing device to respond to gestures including a results-scroll-gesture that scrolls among a plurality of trading cards included in the search result, a flip-gesture that performs a front-back rotation of the enhanced trading card between the trading card front and the trading card rear, and a 3D-rotation-gesture that causes the at least two layers displayed at the different depths in the enhanced image of the trading card front in the rotatable display to float in correspondence to a movable 3D perspective view of the trading card front.

13. The system of claim 10, wherein the instructions further cause the rotatable display to facilitate display of the listing information as the trading card rear while at least one additional trading card included in the search result is concurrently displayed.

14. The system of claim 10, wherein the instructions further cause the computing device to respond to a listing-scroll-gesture that causes the rotatable display to scroll through a plurality of images corresponding to the listing of the trading card, and to a flip-gesture perpendicular to a direction of a results-scroll-gesture that scrolls among a plurality of items included in the search result or to a flip-icon that causes the rotatable display to perform a front-back rotation of the enhanced trading card.

15. The system of claim 10, wherein the instructions further cause the computing device to provide a search result display which lists items included in the search result while maintaining the rotatable display in a context of the search result display.

16. The system of claim 10, wherein the instructions further cause the computing device to provide an indication, superimposed on the enhanced trading card, that highlights at least one physical defect existing in the trading card.

17. The system of claim 16, wherein the at least one physical defect which is indicated includes one or more of a fold, a tear, a scratch, a kink, a scuff, and a bend physically existing in the trading card.

18. The system of claim 10, wherein the trading card is a sports trading card, and wherein the instructions further cause information physically existing on a rear of the sports trading card in the listing information provided to the computing device to replace the rear of the trading card as the trading card rear.

19. A non-transitory computer-readable storage medium storing instructions that, when executed by one or more processors, cause the one or more processors to perform operations comprising:
obtaining an image of a front of a trading card;
segmenting the image of the front of the trading card into at least two layers displayable at different depths for a trading card front;
retrieving listing information corresponding to a listing of the trading card for a trading card rear, the listing information further being adapted to include real-time trending information for additional listings of the trading card; and
responsive to returning the listing of the trading card as at least part of a search result:
communicating to a computing device an enhanced trading card including the trading card front having the at least two layers displayable at the different depths, and the trading card rear having the listing information; and
causing a rotatable display on the computing device of the enhanced trading card comprising the at least two layers displayed at the different depths as an enhanced image of the trading card front, and the listing information as the trading card rear and replacing a rear of the trading card.

20. The non-transitory computer-readable storage medium of claim 19, wherein in the enhanced image of the trading card front in the rotatable display, the at least two layers displayed at the different depths are superimposed on each other, arranged in a depth-order, and are separated by a distance causing the at least two layers to float relative to a movable three-dimensional (3D) perspective view of the trading card front.
